(19) United States
(12) Patent Application Publication
(10) Pub. No.: US 2006/0271690 A1
(43) Pub. Date: Nov. 30, 2006

(54) Developing customer relationships with a network access point

(76) Inventors: Jaz Banga, San Francisco, CA (US); Nitin Shah, Cupertino, CA (US); Brijesh Patel, Gilroy, CA (US); Amul Patel, Pacifica, CA (US)

Correspondence Address: CARR & FERRELL LLP, 2200 GENG ROAD, PALO ALTO, CA, 94303, US

(21) Appl. No.: 11/433,070

(22) Filed: May 11, 2006

Related U.S. Application Data
(60) Provisional application No. 60/680,330, filed on May 11, 2005.

(51) Int. Cl. G06F 15/16

(52) U.S. Cl. 709/228

(57) ABSTRACT

Systems and methods for developing customer relationships with a network access point are provided. In exemplary embodiments, access information and a device identifier is received from an access point. The access information and device identifier may be stored within a device record. A user profile is generated using at least some of the information contained within the device record. A user preference is then provided to identify and maintain relationships with users. The user preference can comprise at least some of the user profile.

### CROSS-REFERENCE TO RELATED APPLICATIONS

The present application claims the benefit of U.S. Provisional Patent Application Ser. No. 60/680,330 entitled “Systems and Methods of Network Operation and Information Processing, Including an Access Point” filed May 11, 2005 the disclosure of which is incorporated herein by reference.

### BACKGROUND OF THE INVENTION

1. Field of the Invention

Embodiments of the present invention are related to developing customer relationships, and more particularly to developing customer relationships with an access point.

2. Related Art

As the number of Internet users grows, content providers and advertisers are having increased difficulty in identifying, creating, and maintaining relationships with their user base. Relationships are limited by current technology. Generally, users interact with content providers and advertisers by accessing a web site on the Internet over a computing device. Users have traditionally been identified by either the user's current destination on the Internet through personal accounts or through downloaded programs on the user's computing device (e.g., cookies).

Many content providers request or require personal accounts from users. When a user creates a personal account, the user is often requested to register and provide personal information that helps the content provider to identify and maintain a relationship with that user. Unfortunately, many users do not register. As a result, many users may stop visiting the content provider's web site. Further, even if a user does create a personal account, the user is often required to login before receiving services or content. Logging in to each web site the user wishes to visit takes time and the user can forget required passwords and usernames.

Other content providers place cookies on user's computing devices. A cookie is a small text file or program that certain Internet sites attach to the user's hard drive within the computing device. A cookie can contain information such as a user identifier, user preferences, shopping information, personally identifiable information, and a list of web sites previously visited. As the user revisits a content provider's web site, the content provider can retrieve the cookie to identify the user and then update the cookie as appropriate. Many users, however, view cookies as an invasion of privacy. As such, many users disable the function that allows cookies to be stored on their computing devices. Further, users can erase their cookies manually or purchase anti-spyware and anti-virus programs which either prevent cookies from downloading or delete cookies entirely (e.g., cookie chum.)

Therefore, there is a need for systems and methods for creating and developing customer relationships on the Internet.

### SUMMARY OF THE INVENTION

Embodiments of the present invention provide systems and methods for developing customer relationships with a network access point. In exemplary embodiments, a method for providing a user preference comprises receiving access information and a device identifier associated with a request for network service from an access point, storing the access information and the device identifier within a device record, generating a user profile based at least in part on the device identifier and the access information within the device record, and providing a user preference associated with the user profile.

The method may further comprise providing a user survey associated with the device identifier, receiving a survey response associated with the user survey, and storing the survey response within the device record. The method may also further comprise providing a user agreement.

Further, the method may further comprise generating a web page with a user agreement to receive network service and transmitting the web page to a network access device.

The access information may comprise an access point identifier. The device identifier may comprise a media access control address or an international mobile station identity. The device record can also be stored within a database.

The user profile may be further based on the survey response. The user profile may also identify at least one individual characteristic of a user or at least one group characteristic of a group of users. The user preference may also be encrypted.

A system for providing a user profile can comprise a profile engine configured to receive access information and a device identifier associated with a request for network service from an access point, store the access information and the device identifier within a device record, generate a user profile based at least in part on the device identifier and the access information within the device record, and provide a user preference associated with the user profile.

A machine-readable medium having embodied thereon a program, the program being executable by a machine and configured to receive access information and a device identifier associated with a request for network service from an access point, store the access information and the device identifier within a device record, generate a user profile based at least in part on the device identifier and the access information within the device record, and provide a user preference associated with the user profile.

### BRIEF DESCRIPTION OF THE DRAWINGS

FIG. 1 is an exemplary block diagram of a system employing embodiments of the present invention.

FIG. 2 is an alternative exemplary block diagram of a system employing an embodiment of the present invention.

FIG. 3 is a block diagram of the customer relationship server, according to one embodiment of the present invention.

FIG. 4 is a flowchart of an exemplary method for providing a user preference to develop customer relationships.

FIG. 5 is a flowchart of another exemplary method for providing a user preference.

FIG. 6 is a flowchart of a method used in an access point in an exemplary embodiment of the present invention.

FIG. 7 is a block diagram of a digital device according to one embodiment of the exemplary embodiment of the present invention.

### DETAILED DESCRIPTION OF EXEMPLARY EMBODIMENTS

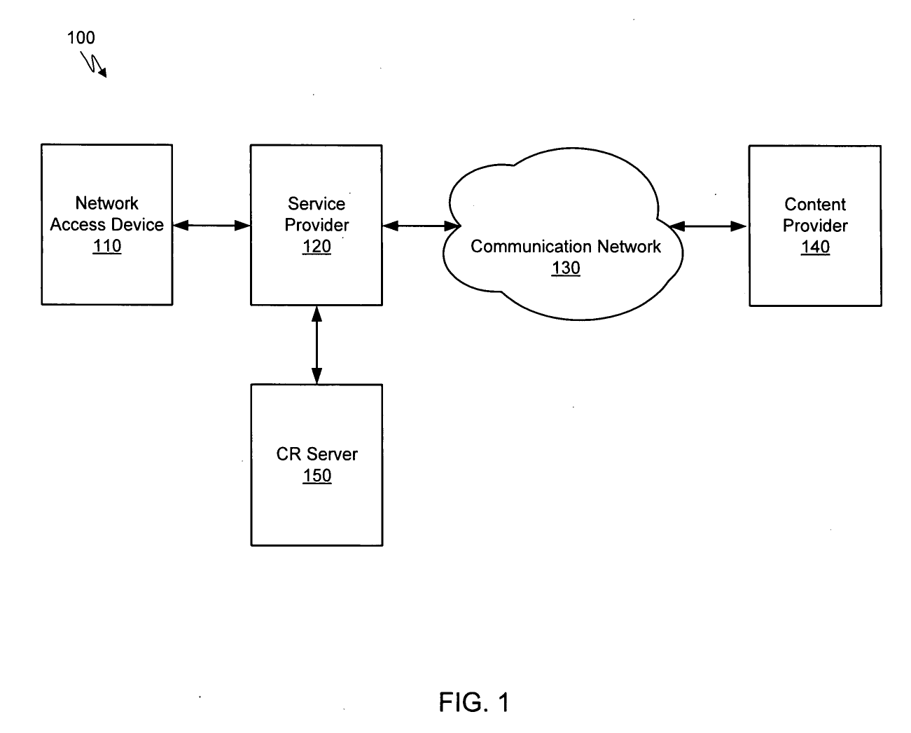

Referring to FIG. 1, an exemplary system 100 in which embodiments of the present invention may be practiced is shown. Unlike many examples of the prior art where users are tracked through cookies on their computing devices (not shown) or the sites the users visit over the Internet, users can be identified and their preferences determined through the user's act of logging onto a network or obtaining network service through a service provider 120 (further discussed below.)

The system 100 comprises a network access device 110, a service provider 120, a communication network 130, a content provider 140, and a client relationship server (“CR server”) 150.

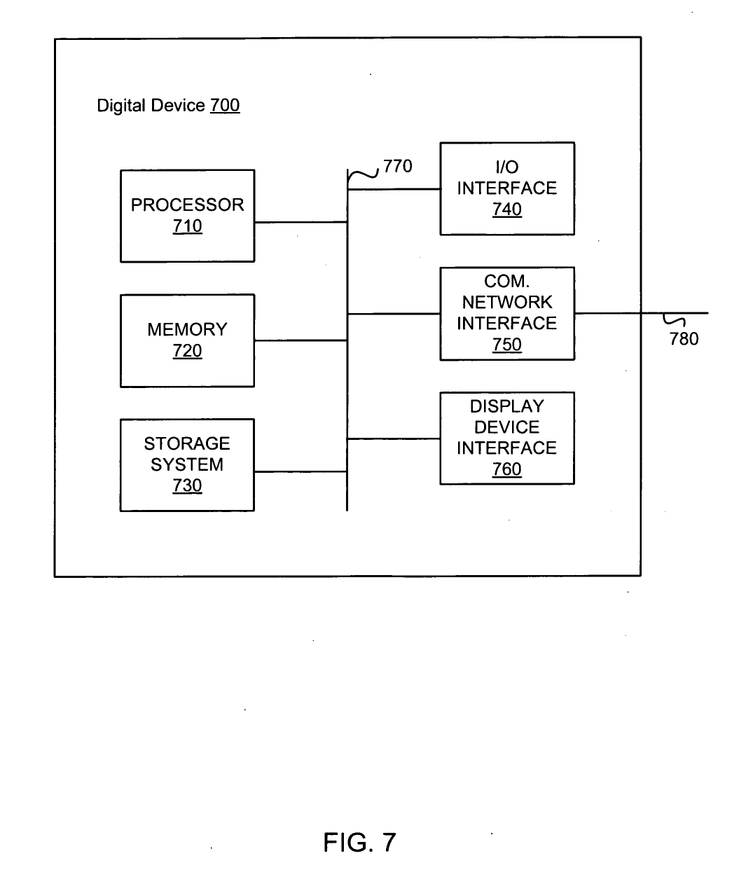

In some embodiments, a potential network user activates a network access device 110. A potential network user is any user that seeks network access over the network access device 110. A network access device 110 is any digital device capable of communicating over a network. The digital device is further discussed in FIG. 7. Examples of network access devices 110 include, but are not limited to, computers, laptops, personal digital assistants, and cellular telephones. Each network access device 110 may contain a device identifier such as a media access control address (i.e., “MAC” address), an international mobile station identity (i.e., “IMSI” identity), or an international mobile equipment identity (i.e., “IMEI” identity.)

The service provider 120 is a device configured to provide the network access device 110 access to the communication network 130. In some examples, the service provider 120 is a switch, bridge, gateway, router, hub, cable modem, phone modem, access point, base station, or combination of these. The service provider 120 is typically controlled by a business that supplies network connectivity (e.g., Internet service provider “ISP”.) In one example, the service provider 120 assigns external IP addresses to network access devices 110 seeking access to the communication network 130.

The communication network 130 comprises a means for connecting two or more network access devices 110 configured to communicate with each other. In some embodiments, the communication network 130 is the Internet, a wide area network (WAN), a local area network (LAN), an intranet, or an extranet. In one example, the user accesses the communication network 130 with the network access device to visit a website provided by the content provider 140.

The content provider 140 is any device configured to provide information to users of network access devices 110 over the communication network 130. In some embodiments, the content provider 140 is a web site. In other embodiments, the content provider 140 is an emailer or a file transport site (FTP) site. The content provider 130 is typically controlled by an individual, group, or business that provides information for viewing or distribution over the communication network 130. In some embodiments, content provided may comprise data, video, audio, or software. In one example, a content provider 140 is a news web site that provides news, advertisements, video, and audio. In another example, a content provider 140 is an advertisement server that serves advertisements to other content providers 140 (e.g., new sites.)

The CR server 150 is any device (not just a server) configured to identify one or more network access devices 110 seeking access to the communication network 130 and generate a user profile. The user profile may be used to build and develop relationships between users of the network access devices 110 and the owners or agents of products and/or services. The CR server 150 may be coupled to the network access device 110, the service provider 120, or the communication network 130. The CR server 150 can be a device and targeting database server (“DTD Server” or “DTDS”).

In one example, a computer user operates a network access device 110 to connect to the communication network 130. The user is identified and the user's preferences determined by the CR server 150 based on the number of times the user seeks communication network 130 access, where the user seeks access, and any other available information. Unlike many examples within the prior art, the CR server 150 may not place cookies on the computer user's network access device 110 nor does the CR server 150 monitor the content providers 140 that the user visits. Rather, the CR server 150 can receive a device identifier from the user's service provider 120. Through the device identifier, the user's network access device 110 can be recognized and information associated with the network access device 110 analyzed.

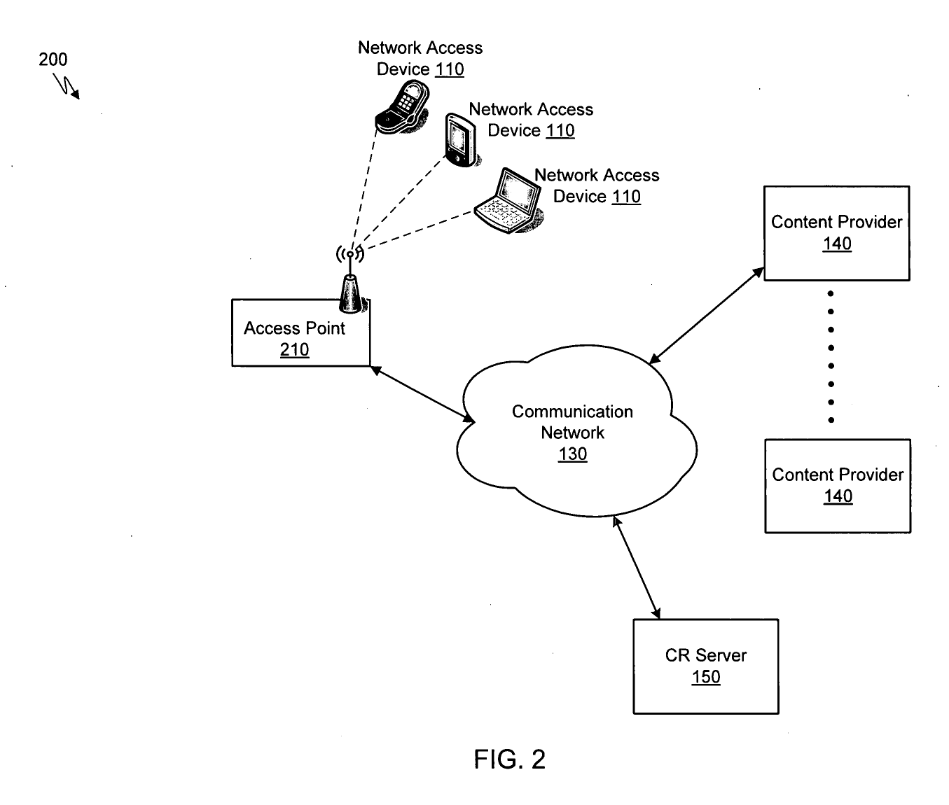

Referring to FIG. 2, an alternative exemplary block diagram employing the present invention is shown. Environment 200 comprises multiple network access devices 110, the communication network 130, multiple content providers 140, and a CR server 150. One or more network access devices 110 are coupled to the access point 210. The access point 210 may also be configured to be implemented over a variety of wireless networks, including wireless fidelity (“WiFi”), worldwide interoperability of microwave access (“WiMax”), or any mobile IP network. Although the network access devices 110 are depicted as coupling to the access point 210 wirelessly, one or more of the network access devices 110 may be coupled to the access point over a wire (e.g., Ethernet, USB, or firewire).

The access point 210 is a device that couples the network access devices 110 to the communication network 130. In exemplary embodiments, the access point 210 may be a base station, router, hub, switch, or any combination. In one example, the access point 210 is a wireless router installed within a business (e.g., coffee shop) that allows users of the network access device 110 Internet access (e.g., a hotspot.)

Although in FIG. 2, the access point 210 is coupled directly to the communication network 130, the access point 210 may be coupled to the communication network 130 through the service provider 120 (FIG. 1). In other embodiments, the access point 210 is, or is a part of, a service provider 120. In one example, when the access point 210 is installed, it negotiates an IP address from the service provider 120. When the network access device 110 seeks network access, the network access device 110 provides the access point 210 a device identifier such as a MAC address. The access point 210 may be configured to authenticate the MAC address and assign an internal IP address to allow the network access device 110 access to the communication network 130 through the access point 210 over the service provider 120.

In some embodiments, the access point 210 comprises hardware, software, or firmware configured to direct the device identifier as well as access information to the CR server 150. In an example, a programmable access point 210 can be upgraded by updating the firmware or adding additional software configured to transmit the device identifier to the CR server 150. In another example, the access point 210 may be purchased already configured. The access point 210 may also be configured to be controlled and updated remotely.

Access information can comprise any information associated with the network access device 110 sending the device identifier to the CR server 150. In one example, access information identifies the access point 210 (such as an IP address or other identifier). The access information may also comprise an access point identifier (e.g., information that identifies the sending access point 210, service provider 120, or device sending the device identifier) information identifying the date and time the network access device 110 seeks access, a type of business that is operating the access point 210, and/or the amount charged to the user of the network access device 110 for service. In other embodiments, a router between the access point 210 and the communication network 130 is configured to direct the device identifier and access information to the CR server 150.

Once the user has obtained access to the communication network 130, the user may use a web browser (e.g., Internet Explorer™) to access a content provider 140. The content provider 140 is coupled to the communication network 130. When a user uses the web browser to visit the content provider 140, the user may see an advertisement. In one example, visitors to the CNN™ website typically see one or more advertisements. The advertisements are often provided by advertisement servers (not depicted.)

The CR server 150 is coupled to the communication network 130. Although the CR server 150 is depicted as coupled to the communication network 130, the CR server 150 may also be coupled to the access point 210, a router, or service provider 120 between the network access device 110 and communication network 130.

The CR server 150 is configured to receive the device identifier and the access information from the access point 210. The device identifier and access information is then stored within a device record. The device record tracks the device identifier and access information. The device record may store any other kind of information associated with the device identifier as well.

In one example, a user may access the communication network 130 from two different access points 210 several times a week. Every time the user seeks network access, the connecting access point 210 sends the user's network access device's device identifier and access information to the CR server 150. Each time the same device identifier is received by the CR server 150, data including the number of times the communication network 130 has been accessed, the access point 210 used, date of access, time of access, location of the access point 210, and associated goods and services of the access point may be stored within the device record. Each different device identifier may have a different device record. The device record may be stored within any data structure, table, or database.

The CR server 150 may generate user profiles based on the information contained within the device record. A user profile may be an individual profile of a user identifying one or more individual characteristics or one or more group characteristics of multiple users. In one example, the user may repeatedly access the communication network 130 with the same network access device 110 through the access point 210 at a coffee shop. As a result, the device record for the device identifier associated with the user may indicate that the user is often at a coffee shop. In this example, the individual characteristic of the user profile may indicate that the user prefers coffee or a particular coffee shop. In another example, an analysis of multiple device records determines that a group of users is identified as repeatedly accessing the communication network 130 within a particular city. The group characteristic may indicate that the users are either residents of the city or frequent visitors.

The CR server 150 may also be configured to generate a user preference based on the user profile. The user preference can be used to determine facts about the user as well as the user's potential preferences. In some embodiments, the user preference is the user profile. In other embodiments, the user preference comprises one or more tags to potentially preferred advertisements or other media. In still further embodiments, the user preference comprises the preferred advertisement or other media. The CR server 150 may provide the user preference to the content provider 140 or the advertisement server (not depicted.) The user preference may be encrypted.

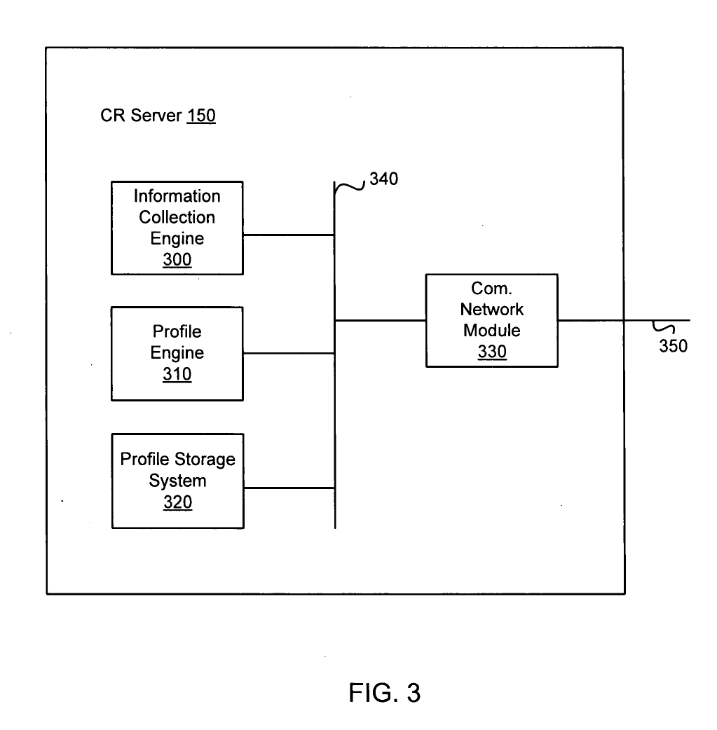

Referring to FIG. 3, a block diagram of the CR server 150 according to one embodiment is shown. The CR server 150 comprises an information collection engine 300, a profile engine 310, a profile storage system 320, and a communication network module (i.e., com. network module) 330 coupled to a bus 340. The communication network module 330 is further coupled to a network link 350.

The information collection engine 300 is configured to receive the device identifier, the access information, and any other information associated with the device identifier. The information collection engine 300 can be further configured to store the device identifier, the access information, and any other information associated with the device identifier within a device record. The device record can be stored within the profile storage system 320.

In some embodiments, the information collection engine 300 is configured to analyze the access information or a device history to determine available information resources. The device history is the number of times the device identifier has been received by the CR server 150 as well as any associated information such as access information. Available information resources are web pages, databases, tables, or any other accessible repository which the information collection engine 300 can access.

In one example, the information collection engine 300 determines that a particular device identifier has been received by the CR server 150 multiple times. The access information associated with each device identifier indicates that the access point 210 (FIG. 2) is within San Francisco, Calif. The information collection engine 300 may store the city and state within the device record. The information engine 300 may also retrieve relevant available information about San Francisco, Calif. (e.g., weather, local events, or types of available business close to access point 210) and store the information within the device record.

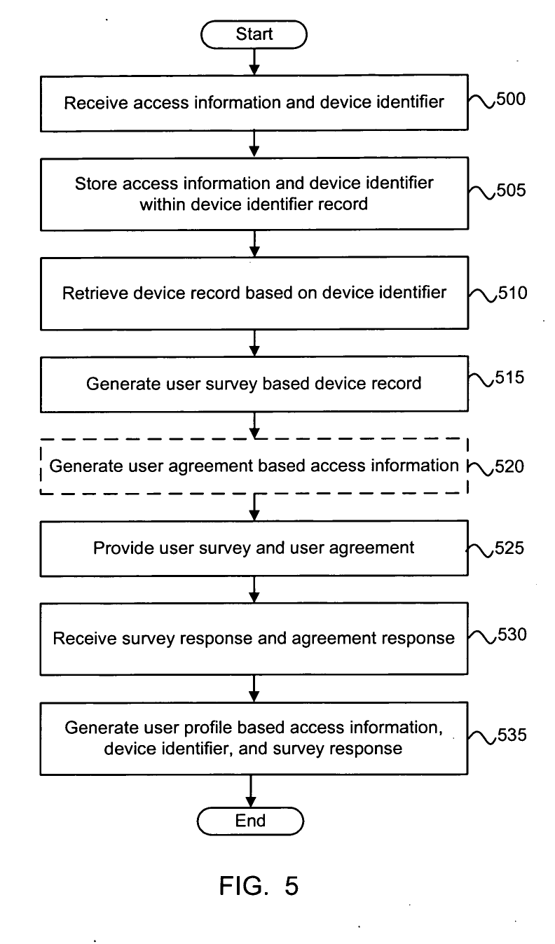

The information collection engine 300 can also generate a user survey and provide the user survey to the access point 210 (FIG. 2). The user survey comprises questions that the user may answer. Survey responses may be collected, organized, and stored within the appropriate device record. The user survey is further discussed in FIG. 5.

The profile engine 310 is configured to retrieve one or more device records and generate user profiles. The user profile may comprise one or more device identifiers, current IP address associated with device identifiers, access information, device histories, or any other information associated with the network access devices 110 (FIG. 2) or device identifiers.

The profile engine 310 can generate user profiles comprising individual characteristics or group characteristics of the user of a network access device 110. In an example, a user profile indicates that the user prefers Starbucks Coffee™ shops. The user profile can also comprise group characteristics of any number of users of different network access devices 110. In an example, a user profile indicates a group of users of a particular gender that live in a specific city and enjoy baseball. Each user profile may identify users through current IP address, device identifier, or any other information compiled to provide assistance in identifying user preferences and/or habits.

The profile storage system 320 is a data structure that is configured to store and retrieve user profiles, user preferences, and device records. The profile storage system 320 can be any data structure, database, or table configured to store, retrieve, and/or organize information.

The communication network module 330 is an interface configured to provide communications to and from the CR server 150 to the network access device 110, access point 210, service provider 120, communication network 130, content provider 140, advertisement server (not depicted) or any other CR server 150. The communication network module 330 is coupled to the network link 350 and the bus 340.

The network link 350 is a link from the CR server 150 to the network access device 110, access point 210, service provider 120, communication network 130, content provider 140, advertisement server or any other CR server 150. The bus is a link that allows the information collection engine 300, the profile engine 310, the profile storage system 320, the communication network module 330, and any other module to communicate.

In some embodiments, the CR server 150 comprises an optional authentication module. The optional authentication module may identify specific device identifiers or any other information contained within the device record. The optional authentication module may then assist the service provider 120 (FIG. 1) to confirm, verify, authenticate, and/or authorize the username, password, or other user identifier. In one example, a thief may attempt to receive network access by posing as another. Although the username and password stolen by the thief may be correct, the authentication module may determine that the device identifier of the thief's network access device 110 is not the device identifier associated with that user. The optional authentication module may then alert the service provider 120.

The optional authentication module can also provide additional security to the content provider 140 and/or the service provider 120. In an example, PayPal provides a PayPal unique address to the CR server 150 which is subsequently stored in a device record. When the user of a network access device 110 successfully completes a transaction over PayPal, the optional authentication module can confirm that each subsequent transaction is made by the same network access device 110 thereby allowing extra security to PayPal to avoid fraud. If a different network access device 110 is used to access a PayPal account, the optional authentication module can alert PayPal. As a result, PayPal may require additional passwords or security before allowing the user to make transactions. In some embodiments, content providers 140 such as PayPal forego passwords and rely on authentication of the network access device 110 through the optional authentication module of the CR server 150. Although PayPal is discussed as an example, the optional authentication module can provide additional security to any transaction on a communication network 130 including, but not limited to, credit card transactions.

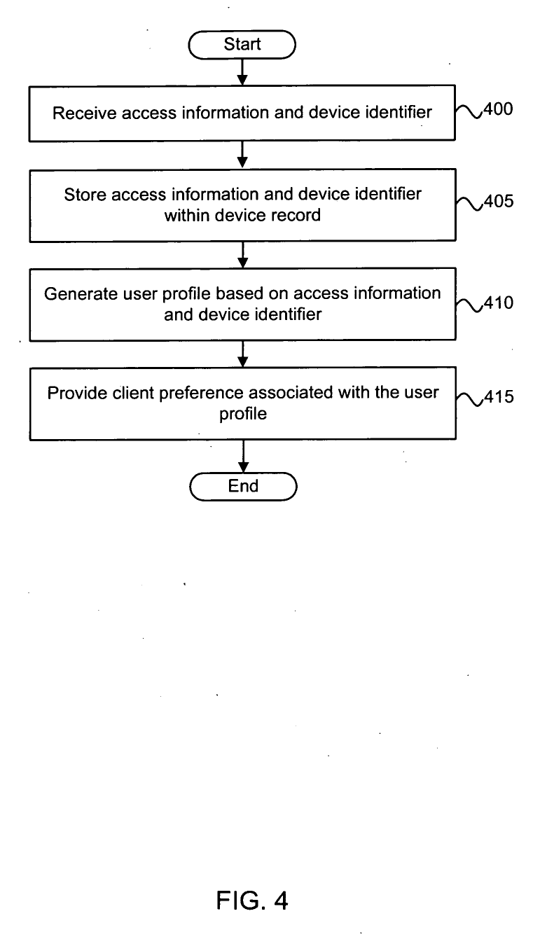

FIG. 4 is a flowchart of an exemplary method for providing a user preference to develop customer relationships. In step 400, the CR server 150 (FIG. 2) receives access information and the device identifier. In some embodiments, the access information is received from the access point 210 (FIG. 2). The CR server 150 may receive access information from any device that provides network access to the network access device 110 (FIG. 1)

In some embodiments, the device identifier is unique and identifies the network access device 110. In an example, if the network access device 110 can receive an IP address, the device identifier may be the MAC address. In another example, the network access device 110 is a cellular telephone capable of accessing the communication network 130. The device identifier of a cellular telephone may be an IMSI identity.

In other embodiments, the device identifier identifies a category of network access devices 110. The category can identify a specific type of digital device or a general class. In an example, the network access device 110 may be a Sony PSP™ capable of accessing the communication network 130. In this case, the device identifier may identify the network access device 110 as a Sony PSP™. Alternately, the device identifier may identify the network access device 110 as a gaming device.

In step 405, the CR server 150 stores the access information and the device identifier within a device record. In some embodiments, if the device identifier has not previously been received by the CR server 150, the CR server 150 creates a device record associated with the device identifier. The device record can further store current and past IP addresses, the device history, and any other information that may be associated with the device identifier and/or the access information.

In step 410, the CR server 150 generates a user profile based on the access information and the device identifier. The user profile may also be based on the device history or other information associated with the device identifier. In some embodiments, user profiles are identified by recognizing general trends within the digital records. In an example, a high number of users may be male within a certain range of ages and seek network access within a specific football stadium. A user profile may be generated for males within an age range that prefer football. Other user profiles may be generated including a user profile for males who prefer sports or a user profile that associates users within an age range and sports.

In another embodiment, predetermined user profiles may be generated. In an example, a soft drink company may wish to direct advertisements to a certain demographic at certain times of day in the summer. A user profile can be generated that identifies device identifiers and current IP addresses with users who fit the demographic. Access information may indicate the time of day they are accessing the communication network 130 and the location of the access point 210 including city and state. Further, the CR server 150 may check the weather of the city and state from resources available on the Internet to include those users in hot climates and temperatures to be included within the user profile.

In step 415, the CR server 150 provides the user preference associated with the user profile. The user preference can assist third parties to identify, develop, and maintain relationships with the user without tracking cookies or requiring separate user accounts. The user preference can be transmitted to an advertisement server or a content provider 140.

The user profiles can be used to determine the potential preferences of the users. As such, the user preference may comprise a user profile or parts of the user profile. In some embodiments, the user preference may be an advertisement tag. In an example, the CR server 150 may receive an index of advertisements and associated advertisement information (e.g., brands associated with the advertisements.) A device record may refer to a user currently accessing a content provider 140. Instead of placing a random advertisement on the content provider 140 for the user to see, the advertisement server may direct a request for an advertisement tag with the user's IP address to the CR server 150. The CR server 150 can then check the user profiles for the user using the user's IP address. If the user is within a user profile or a user profile can be generated from a device record, then the CR server 150 will use the user profile to select an advertisement from the index of advertisements that satisfy the requirements of the advertisement server and fit the user profile. The advertisement tag (i.e., user preference) can then be sent to the advertisement server which, in turn, can provide the proper advertisement to the content provider 140. In other embodiments, the user preference may be the advertisement.

FIG. 5 is a flowchart of another exemplary method for providing a user preference. In step 500, the CR server 150 (FIG. 2) receives access information and the device identifier from an access point 210. The access information and the device identifier are stored within the device record in step 505. In one example, the CR server 150 retrieves the device record associated with the device identifier. If no device record associated with the device identifier is found, then a device record is created. Once the device record is found or is created, the access information and device identifier are stored.

In step 510, the CR server 150 retrieves the device record associated with the device identifier. In some embodiments, step 510 is optional if the device record was previously retrieved in step 505.

In step 515, a user survey is generated based on the retrieved device record. The user survey may be different for each user depending on the information contained within the device record. In an example, the user survey contains one or more questions designed to gather information regarding the user associated with a particular device identifier. Each time the user of the network access device 110 (FIG. 2) with the device identifier requests network access, another user survey may be generated with one or more different questions designed to better identify the user's interests and preferences. In some embodiments, user surveys are no longer generated after the user has answered a predetermined number of survey questions. In a different example, each user may receive the same user survey or each user may receive a different user survey each time they request network services. There may be any number of questions within each survey. The questions may range from personal facts (e.g., age, gender), preferences (e.g., cola, clothes), or even topical information such as awareness of local events.

In optional step 520, the CR server 150 generates a user agreement based on the access information. The user agreement may comprise terms and conditions that the user must agree to before obtaining network access or receiving the benefits of user preference and user profile generation. In some embodiments, the user agreement can be different for different access points 210 identified by the access information. The user agreements may be stored or generated for different access points 210 as needed.

In step 525, the CR server 150 provides the user survey and the optional user agreement. In one embodiment, the user survey and optional user agreement are resident on the CR server 150 and will be sent to the access point 210 upon request. In another embodiment, the user survey and optional user agreement are transmitted to the access point 210.

Upon retrieving or receiving the user survey and the optional user agreement from the CR server 150, the access point 210 provides the user survey and the optional user agreement to the network access device 110 requesting network access. In some embodiments, the access point 210 or an associated web server transmits a web page to the network access device 110. The web page may be a home page or a “splash” page that requires the user to view the page and optionally to agree to specific terms and conditions required for network access. The user survey and the optional user agreement may be displayed to the user on the web page.

The user may respond to the user survey, the terms and conditions of the web page, and the optional user agreement. In one example, the user enters answers to the user survey, agrees to the terms and conditions of the web page as well as the optional user agreement. These responses are then transmitted to the access point 210 which redirects the survey response and the optional agreement response to the CR server 150. If the user does not agree to the terms and conditions of the web page or the optional user agreement, then the method of FIG. 5 ends.

In step 530, the CR server 150 receives the survey response and the optional agreement response. The responses may be stored within the appropriate device record associated with the user's device identifier. If the optional agreement response indicates that the user does not agree, then the method of FIG. 5 ends.

In step 535, the user profile is generated based on access information, the device identifier, and the survey responses. The user profile may also be based on any other information contained within the device record including device history or other information related to the access information (e.g., location of access point, weather at location, and current local events.)

Although FIG. 5 discusses an interaction with an access point 210, the interaction may be with any network device capable of providing network access to a network access device 110 (FIG. 2). Some examples include, but are not limited to, routers, switches, or service providers 120.

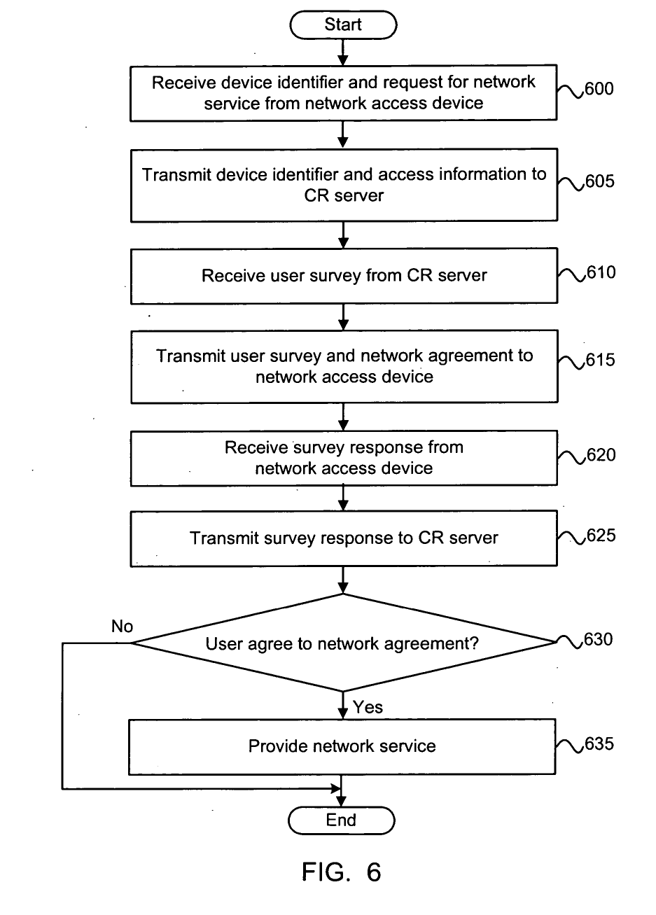

Referring to FIG. 6, a flowchart of an exemplary method for an access point 210 (FIG. 2) is shown. In step 600, the access point 210 receives the device identifier and the request for network service from the network access device 110 (FIG. 2). In one example, a user wishes to obtain network access over the user's network access device 110 at hotspot within a local coffee house. When the user activates the network access device 110 and executes a web browser, the network access device 110 sends a device identifier with a request for network access to the access point 210. In this example, the device identifier is a MAC address.

In step 605, the access point 210 transmits the device identifier and the access information received from the network access device 110 to the CR server 150. In some embodiments, software resident on the access point 210 automatically sends the device identifier of any network access device 110 seeking network access. The access information may comprise the IP address of the sending access point 210.

The CR server 150 can receive and store the device identifier and access information from the access point 210. The CR server 150 can generate a user survey based on the device identifier. In step 610, the access point 210 receives the survey from the CR server 150. In some embodiments, the CR server 150 transmits the user survey to the access point 210 without a survey request from the access point 210. In other embodiments, the access point 210 transmits a user survey request to the CR server 150 or pulls the user survey from the CR server 150.

In step 615, the access point 210 transmits the user survey and a network agreement to the network access device 110. In some embodiments, the access point 210 or a related web server transmits the user survey and network agreement to the network access device 110 on a web page. The user of the network access device 110 may see the page through the web browser prior to receiving network access. The user may then answer one or more user survey questions and send the survey response to the access point 210 in step 620.

In step 625, the access point 210 transmits the survey response received from the network access device 110 to the CR server 150. In addition to the survey response, the access point 210 may also send access information to the CR server 150. The CR server 150 can receive and store the survey response and/or access information within a device record.

In step 630, the access point determines if the user of the network access device 110 agrees to the network agreement. In some embodiments, the user is asked to click on a button within the web page that includes the network agreement. If the user agrees to the network agreement, the access point 210 can then provide network service or network access in step 635. If the user does not agree to the network agreement, the method of FIG. 6 ends.

FIG. 7 is a block diagram of a digital device 700 according to one embodiment of the exemplary embodiment. The digital device 700 includes a system bus 770 coupled to a processor 710, memory 720, storage system 730, input/output (I/O) interface 740, communications (com.) network interface 750, and display interface 760. The communications network interface 750 is further coupled to an external communications link 780. The I/O interface 740 and the display interface 760 can be optional. The network access device 110 (FIG. 2), CR server 150 (FIG. 2), the access point 210 (FIG. 2), and the service provider 120 (FIG. 1) may be digital devices 700.

The processor 710 is configured to execute software or instructions. The memory 720 is any memory device configured to hold data, either permanently or temporarily, to make the data available to any components connected to the system bus 770. The memory 720 may comprise battery-backed random access memory or read-only memory (ROM).

The storage system 730 is any storage device or group of storage devices configured to store data permanently or temporarily. In one embodiment, the storage system 730 implements a Read/Verify-after-Write (RVAW) policy where data is verified after being stored within the storage system 730. Further, the storage system 730 may comprise a storage device configured to receive and read external media. In some embodiments, the user profiles, user preferences, and/or device records are stored within the storage system 730. The storage system 730 and/or the memory 720 may comprise a machine readable medium.

The I/O interface 740 is any interface or device configured to provide input or output to the player of the digital device 700. For example, the I/O interface 740 may comprise a video interface, audio interface, a remote control, a keypad, joystick, touch-screen, track-pad, or buttons.

The communications network interface 750 is any communication interface configured to transfer data between any components connected to the system bus 770 and any network over the external communications link 780. The external communications link 780 couples the digital device 700 to any communications network 130 (FIG. 2).

Embodiments of the present invention have been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for providing a user preference, comprising:
receiving access information and a device identifier associated with a request for network service from an access point;
storing the access information and the device identifier within a device record;
generating a user profile based at least in part on the device identifier and the access information within the device record; and
providing a user preference associated with the user profile.

2. The method of claim 1 further comprising:
providing a user survey associated with the device identifier;
receiving a survey response associated with the user survey; and
storing the survey response within the device record.

3. The method of claim 2 wherein the user profile is further based on the survey response.

4. The method of claim 1 further comprising providing a user agreement.

5. The method of claim 1 further comprising:
generating a web page with a user agreement to receive network service; and
transmitting the web page to a network access device.

6. The method of claim 1 wherein the access information comprises an access point identifier.

7. The method of claim 1 wherein the device identifier comprises a media access control address.

8. The method of claim 1 wherein the device identifier comprises an international mobile station identity.

9. The method of claim 1 wherein the device record is stored within a database.

10. The method of claim 1 wherein the user profile identifies at least one individual characteristic of a user.

11. The method of claim 1 wherein the user profile identifies a group of users as sharing at least one group characteristic.

12. The method of claim 1 wherein the user preference is encrypted.

13. A system for providing a user profile, comprising:
a profile engine configured to receive access information and a device identifier associated with a request for network service from an access point, store the access information and the device identifier within a device record, generate a user profile based at least in part on the device identifier and the access information within the device record, and provide a user preference associated with the user profile.

14. The system of claim 13 wherein the profile engine is further configured to provide a user survey associated with the device identifier; receive survey response associated with the user survey, and store the survey response within the device record.

15. The system of claim 14 wherein the user profile is further based on the survey response.

16. The system of claim 13 further comprising providing a user agreement.

17. The system of claim 13 wherein the user profile engine is further configured to generate a web page with a user agreement to receive the network service and transmit the web page to a potential network service user.

18. The system of claim 13 wherein the access information comprises an access point identifier.

19. The system of claim 13 wherein the device identifier comprises a media access control address.

20. The system of claim 13 wherein the device identifier comprises an international mobile station identity.

21. The system of claim 13 wherein the device record is stored within a database.

22. The system of claim 13 wherein the user profile identifies at least one individual characteristics of a user.

23. The system of claim 13 wherein the user profile identifies a group of users as sharing at least one group characteristic.

24. The system of claim 13 wherein the user preference is encrypted.

25. A machine-readable medium having embodied thereon a program, the program being executable by a machine and configured to receive access information and a device identifier associated with a request for network service from an access point, store the access information and the device identifier within a device record, generate a user profile based at least in part on the device identifier and the access information within the device record, and provide a user preference associated with the user profile.

26. The program of claim 25 wherein the profile engine is further configured to provide a user survey associated with the device identifier, receive a survey response associated with the user survey from, and store the survey response within the device record.

27. The program of claim 26 wherein the user profile is further based on the survey response.

28. The program of claim 25 wherein the user preference is encrypted.
